(19) United States
(12) Patent Application Publication
(10) Pub. No.: US 2002/0027060 A1
(43) Pub. Date: Mar. 7, 2002

(54) Method for a gap-free line-up of containers supplied successively from a pick-up section

(76) Inventors: Manfred Boller, Hohentengen (DE); Jean-Claude Oppliger, Niederhasli (CH)

Correspondence Address: Friedrich Kueffner, Suite 1921, 342 Madison Avenue, New York, NY, 10173, US

(21) Appl. No.: 09/784,672

(22) Filed: Feb. 15, 2001

Related U.S. Application Data
(62) Division of application No. 09/283,512, filed on Apr. 1, 1999, now abandoned.

(30) Foreign Application Priority Data
Apr. 9, 1998 (EP) 98810308.1-2308

(51) Int. Cl. B65G 43/00

(52) U.S. Cl. 198/460.1

(57) ABSTRACT

A method and an apparatus for a gap-free line-up or placement of containers successively supplied from a pick-up section, wherein the containers can be removed from the pick-up section as desired. The container removed from the pick-up section and the containers following the removed container on the subsequent pick-up section as seen in the conveying direction of the containers cause an automatic conveyance of the respectively subsequent container which results in a filling of the gap left by the removed container. The apparatus is composed of a pick-up section for supplied containers provided with a plurality of drivable rollers which are arranged transversely of the conveying or feeding direction of the containers and which form a conveying plane. In the apparatus according to the present invention, the pick-up section is formed by conveying sections arranged in a row or one behind the other in the conveying direction, wherein the conveying sections are constructed as placement locations for the containers, and conveying by the conveying sections can be switched automatically on and off by the containers or by the removal of the containers, so that a reliable and essentially problem-free processing of the containers is ensured.

### BACKGROUND OF THE INVENTION

1. Field of the Invention

The present invention relates to a method for a gap-free line-up or placement of containers successively supplied from a pick-up section, wherein the containers can be removed from the pick-up section as desired.

2. Description of the Related Art

Methods of the above-described type can be used, inter alia, in sorting plants for mail pieces, filling plants for foodstuffs or magazine shipping plants, where it is the object to make available a constant number of containers to be processed.

### SUMMARY OF THE INVENTION

It is the primary object of the present invention to develop a method of the above-described type which ensures a high processing speed and reliability and is simple to use.

In accordance with the present invention, the container removed from the pick-up section and the containers following the removed container on the subsequent pick-up section as seen in the conveying direction of the containers cause an automatic conveyance of the respectively subsequent container which results in a filling of the gap left by the removed container.

The measure according to the present invention makes it possible that when an individual container or several containers are removed, a permanently complete occupation of the pick-up section with containers is ensured and a reliable processing in different fields of application can be carried out.

Particularly suitable in this connection are sorting plants for shipping flat piece goods as utilized by mail services, mail order services or booksellers or printing plants, as described, for example, in European Patent Documents 0 638 501 and 97810617.

In accordance with an advantageous feature, it is also possible to simultaneously remove one or more containers over the entire length of the pick-up section and to fill the gaps left by the removed containers by conveying the containers which are already on the pick-up section or are supplied to the pick-up section. Of course, it is possible, in accordance with the present invention, to immediately close the gaps left by several removed containers which were previously arranged next to one another.

In accordance with a useful feature, the pick-up section is formed by several conveyor sections which serve as placement locations for the containers, wherein the occupation of a placement location causes the container located on the conveyor section adjacent upstream the occupied placement location to be held up on its placement location, so that a precise and rapid assignment of the containers to the processing locations is achieved.

Accordingly, it is advantageous if a container which leaves the placement location in a downstream direction releases the container held back in the upstream direction in order to convey the latter container, so that a mutual coordination among the containers takes place.

The containers can be supplied next to each other in the direction of extension of the pick-up section or transversely of the direction of extension of the pick-up section; for this purpose, several parallel tracks lead into the pick-up section.

For carrying out the method according to the present invention, an apparatus is proposed which has all the criteria which are essential for the invention, wherein the apparatus is composed of a pick-up section for supplied containers provided with a plurality of drivable rollers which are arranged transversely of the conveying or feeding direction of the containers and which form a conveying plane. In the apparatus according to the present invention, the pick-up section is formed by conveying sections arranged in a row or one behind the other in the conveying direction, wherein the conveying sections are constructed as placement locations for the containers, and conveying by the conveying sections can be switched automatically on and off by the containers or by the removal of the containers, so that a reliable and essentially problem-free processing of the containers is ensured.

In accordance with a further development of the apparatus of the present invention, a switching device which can be actuated by a supplied container is arranged in the intermediate area between two adjacent conveying sections and assigned to the placement location of the conveying section arranged downstream, wherein the switching device is connected to the stopping element of a locking device which can be switched on and off and is assigned to the placement location of the conveying section arranged upstream, so that a precise transfer of the containers between the placement locations can take place in a simple manner.

In order to prevent the conveyance by lifting the stopping element above the conveying plane, the switching device connected to the locking device can be moved by a container placed on the placement location of a conveying section into a mutually acting locking position which prevents the conveyance at the adjacent upstream conveying section.

In accordance with a simple embodiment of the apparatus according to the present invention, the switching device includes an actuating lever which can be swivelled about an axis arranged transversely of the conveying direction of the containers and which can be pivoted into the conveying plane by a container conveyed on a conveying section in order to lock the switching device and locking device; the switching device further includes a pawl for engagement in the actuating lever, wherein the pawl is hinged to the stopping element of the locking device which is constructed so as to be capable of swivelling as a lever about an axis.

The pawl preferably has a recess which surrounds at a distance a shaft arranged in the axis of the actuating lever for limiting the swivelling movement of the pawl.

However, the swivelling lever above the conveying plane can be limited by a guide stop formed at the pawl.

In order to simplify the apparatus according to the present invention, the actuating lever has on the side located opposite the axis a cam provided for engagement of the pawl.

A pretensioned tension spring connecting the actuating lever and the stopping element is provided for lifting the actuating lever out of the conveying plane after a container has left and for adjusting the stopping element of the locking device constructed as a lever.

The operational relationship between the switching device and the locking device remain intact if the force of the tension spring is smaller than the force produced by the container running up against the stopping element constructed as a lever.

In order to achieve a simple bearing arrangement, the axes of the actuating lever and of the stopping element are distributed concentrically on the axes of two adjacent rollers.

A simple drive of the pick-up section has been found to be an endless traction means, for example, a flat belt, a toothed belt or chains, which is connected so as to drive the conveying rollers.

In order to prevent the containers from turning on the pick-up section, the switching and locking devices can each be provided on both sides of the pick-up section.

In accordance with an advantageous feature, the stopping elements of the locking device are connected through at least one rod extending transversely of the conveying direction of the containers, so that the containers are acted upon by the rod over their entire width.

In accordance with an alternative feature, the switching and locking device may be arranged approximately in the longitudinal middle of the pick-up section, wherein, for this purpose, when the roller axes are used as the axis of the actuating element and the stopping element of the locking device, the rollers must be interrupted where the locking device is arranged.

In accordance with an equivalent alternative embodiment, the apparatus according to the present invention is composed of a pick-up section for successively supplied containers composed of a plurality of drivable rollers which are arranged transversely of the conveying direction of the containers and form a conveying plane; the switching device includes an actuating lever which can be swivelled about an axis arranged transversely of the conveying direction of the containers; the actuating lever is provided for the releasable locking of the switching and locking device, particularly for holding up a subsequently conveyed container by a container which is moved downstream or is placed on a conveying plane, wherein the actuating lever is formed by a bolt fastened oppositely at the swivel axis and holding in a locked position a locking member of the locking device rotatably arranged about a parallel axis.

It has been found useful if the locking member has an equilateral triangular shape uniformly distributed around the axis with side surfaces extending parallel to the axis; this makes the operation controllable in a simple manner.

On the one hand, the locking member moved into the locking position forms a perpendicular side surface facing the supplied container and, on the other hand, the bolt reinforces the actuating lever placed under load by the downstream next container at the opposite edge of the triangle of the locking member, so that the container is held up at the locking member even though the pick-up section is driven for conveying the containers.

When the pick-up section is completely occupied, the locking member can be switched off by an appropriate signal and can be switched on again by one or more gaps which are created.

The rotatability and the triangular cross-sectional shape of the locking member provide the significant advantage that the perpendicular side surface of the locking member which causes a container to be stopped produces an at least approximately coplanar plane with the conveying plane of the pick-up section after the locking of the switching and locking device has been cancelled by a container which has run up and effects a rotary movement.

Locking of the locking member in this position is achieved by the container which swivels or travels over the previously upwardly extending side surface.

In the free-standing position of the locking member in which a container has moved away from the locking member, the locking member is returned by an adjusting device into the locking position and is held in this position by the actuating lever which is pressed downwardly by the container, so that the next following container is held up at least until the previous container has moved away or has been removed from this row of containers.

In accordance with an advantageous feature, the centroidal line of the locking member having an equilateral triangular cross-section forms the axis of rotation thereof, so that a certain regularity in the rotary movement of the locking member is produced.

In order that the different width dimensions of the containers do not impair the conveyance and position thereof, the locking member advantageously has at least approximately the length of a supporting roller of the pick-up section.

The actuating lever is advantageously attached to a shaft extending parallel to the axis of the locking member, such that each of the containers having different widths is capable of moving the actuating lever.

In order to make it possible that the locking member can be returned from the position in which the containers can pass through into the locking position, at least one end face of the locking member is formed by a locking wheel of a plate spring which engages the locking member and is mounted on a frame.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a partial elevational view of an apparatus according to the present invention;

FIG. 2 is a partial top view of the apparatus of FIG. 1;

FIG. 3 is a partial side view, on a larger scale, of a detail of the apparatus of FIGS. 1 and 2, shown with the containers standing still;

FIG. 4 is a view corresponding to FIG. 3, shown with the containers being moved;

FIG. 5 is a view similar to FIGS. 3 and 4, shown with the containers passing through;

FIG. 6 is a partial elevational view of another embodiment of an apparatus according to the present invention;

FIG. 7 is a partial top view of the apparatus of FIG. 6;

FIG. 8 is a partial side view, on a larger scale, of a detail of the apparatus of FIGS. 6 and 7, shown with the containers standing still;

FIG. 9 is a view corresponding to FIG. 8, shown with the containers being moved;

FIG. 10 is a view similar to FIGS. 8 and 9, shown with the containers passing through;

### DESCRIPTION OF THE PREFERRED EMBODIMENTS

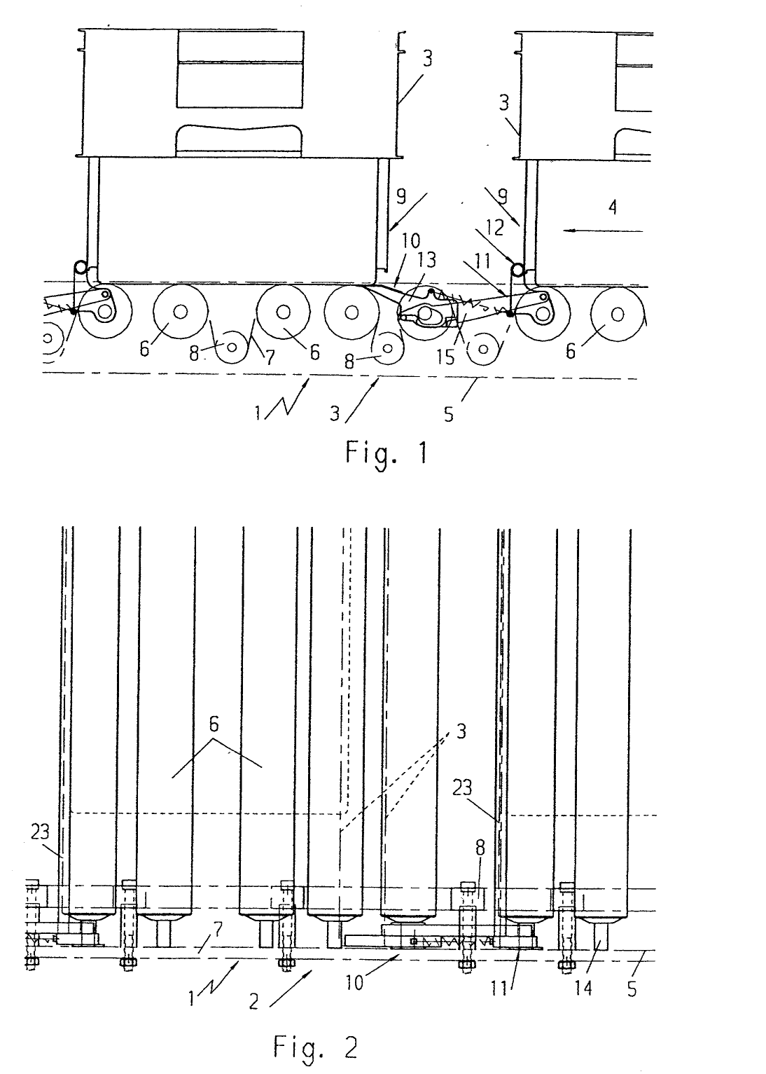

FIGS. 1-5 of the drawing show an apparatus 1 for carrying out the method according to the present invention for a gap-free line-up of containers 3 supplied successively from a pick-up section 2, wherein the containers 3 can be selectively removed from the row in the pick-up section 2 for further processing. Arrow 4 in FIG. 1 designates the conveying direction of the containers 3 on the pick-up section 2; for example, the containers 3 are made available for filling with flat mail pieces, such as letters, magazines, etc. from a sorting plant which is not shown, wherein the length of the pick-up section 2 corresponds to the length of a sorting section which extends parallel to the pick-up section 2, so that containers filled by the sorting plant can be exchanged at a target location against an empty container. This takes place in irregular intervals and is true over the length of the pick-up section for all conveying sections.

FIG. 1 is a partial illustration of a stationary pick-up section 2 which is composed of a plurality of rollers 6 which are arranged spaced apart from each other transversely of the conveying direction 4 and are rotatably mounted in a frame 5. These rollers 6 form a conveying plane on which the containers 3 are moved; the rollers 6 are driven on at least one side thereof by an endless drive belt 7 which partially surrounds the rollers 6. In order to increase the angle of contact, additional guide rollers 8 may be arranged between two rollers 6 as illustrated in FIG. 1.

The pick-up section 2 is divided into several conveying sections 9 which are adapted, for example, to the length of a target location section or a sorting section of a sorting plant, wherein a container 3 is assigned to each conveyor section 9. These conveying sections 9 are constructed as placement locations for the containers 3 and the placement locations of two successive conveying sections 9 are connected through a switching device 10 and a locking device 11 which are coupled to each other. The switching device 10 is assigned to the rearward end of a conveying section 9 as seen in the conveying or supplying direction, and the locking device 11 is assigned to the front end of the conveying section 9 located adjacent in the direction opposite the conveying direction.

The removal of the containers 3 at the pick-up section 2 takes place transversely of the conveying direction 4, preferably in a horizontal plane.

When the switching device 10 is actuated by a container 3 which enters or travels through or is supplied to a conveying section, a stopping element 12 of the locking device 11 is placed in the locking position at the conveying end of the adjacent upstream conveying section 9, so that a subsequent container 3 is held up. When the leading container 3 leaves its placement location where it travels downstream through a conveying section 9, the container 3 moves away from the switching device 10, and, as a result, releases the conveying path for the next following container 3 located on the adjacent upstream conveying section 9.

FIG. 2 illustrates the arrangement of the rollers 6 and of the switching device 10 and the locking device 11, as well as the other structural components discussed above which are attached to the frame 5.

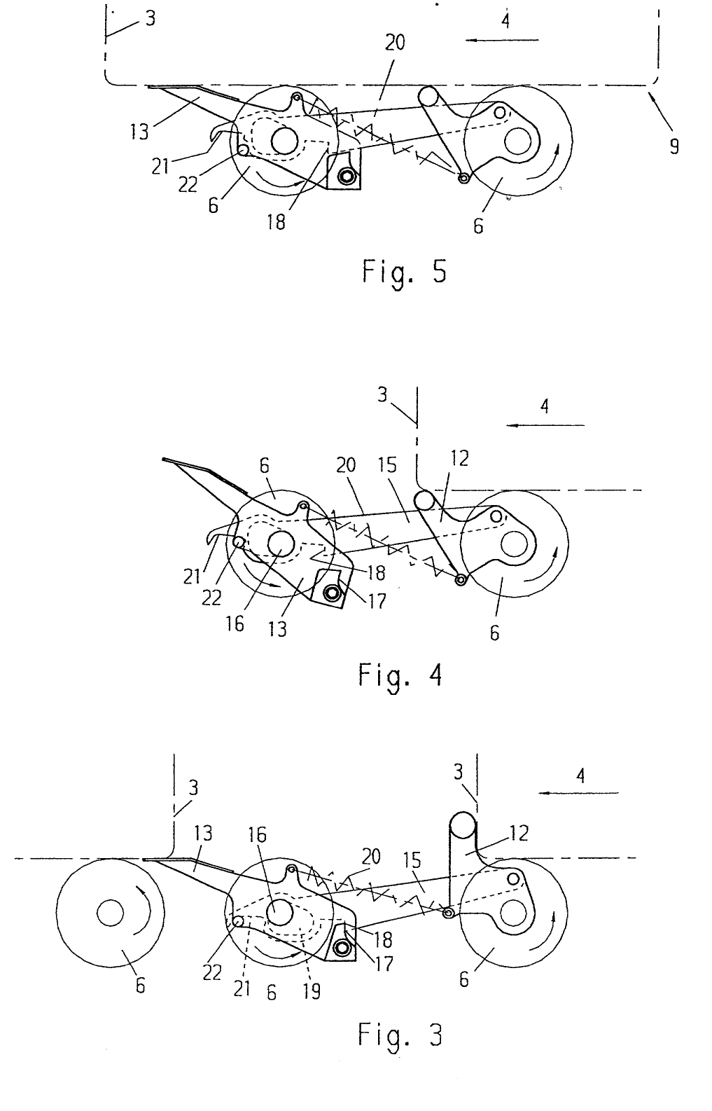

In the following, the configuration and manner of operation of the switching device 10 and the locking device 11 connected to the apparatus 1 according to the present invention will be explained in connection with FIGS. 3-5.

FIG. 3 shows the switching device 10 and the locking device 11 in the locked position in which the forward container 3, by pressing down an actuating lever 13 which belongs to the switching device 10 and is swivellably mounted on a roller axis 14, holds through a pawl 15 the stopping element 12 of the locking device constructed as a lever in the position of operation and, thus, prevents the trailing container 3 from moving further. The pawl 15 is with one end thereof hinged to the lever-like stopping element 12 of the locking device 11 and rests at the other end thereof through an expanded recess 19 on a shaft journal 16 of a roller 6 which receives and supports the actuating lever 13. A cam 17 which engages in a locking groove 18 of the pawl 15 is fastened on the actuating lever 13 on the side located opposite the axis in order to secure the reinforced connection between the switching device 10 and the locking device 11. The swivelling movement of the pawl 15 for engaging and releasing the locked connection is effected by an expanded recess 19 which surrounds the shaft journal 16 of a roller 6.

When a container 3 has left a placement location or a conveying section 9 as illustrated in FIG. 4, the actuating lever 13 is moved upwardly as a result of the pulling force of a spring 20, to the extent permitted by the recess 19 of the pawl 15 and by a bolt 22 attached as a guide stop 21 at the actuating lever 13. This causes the actuating lever 13 to be disengaged from the cam 17 and the pawl 15 is displaced by the force of the subsequent container 3 driven on the pick-up section 2 through the downwardly pressed stopping element 12 constructed as a lever, until the edge on the right hand side of the recess 19 makes contact with the shaft journal 16. The container 3 which in FIG. 5 already presses down the actuating lever 13 leaves the adjacent upstream conveying section 9; subsequently, the stopping element 12 and the pawl 15 are pulled back by the spring 20 and are locked by engagement by the cam 17, as illustrated in FIG. 3.

To ensure that containers 3 of any width are held back by the stopping element 12, a rod 23 is provided which extends transversely of the conveying direction 4 and connects the lever-like stopping elements 12 on both sides of the pick-up section 2.

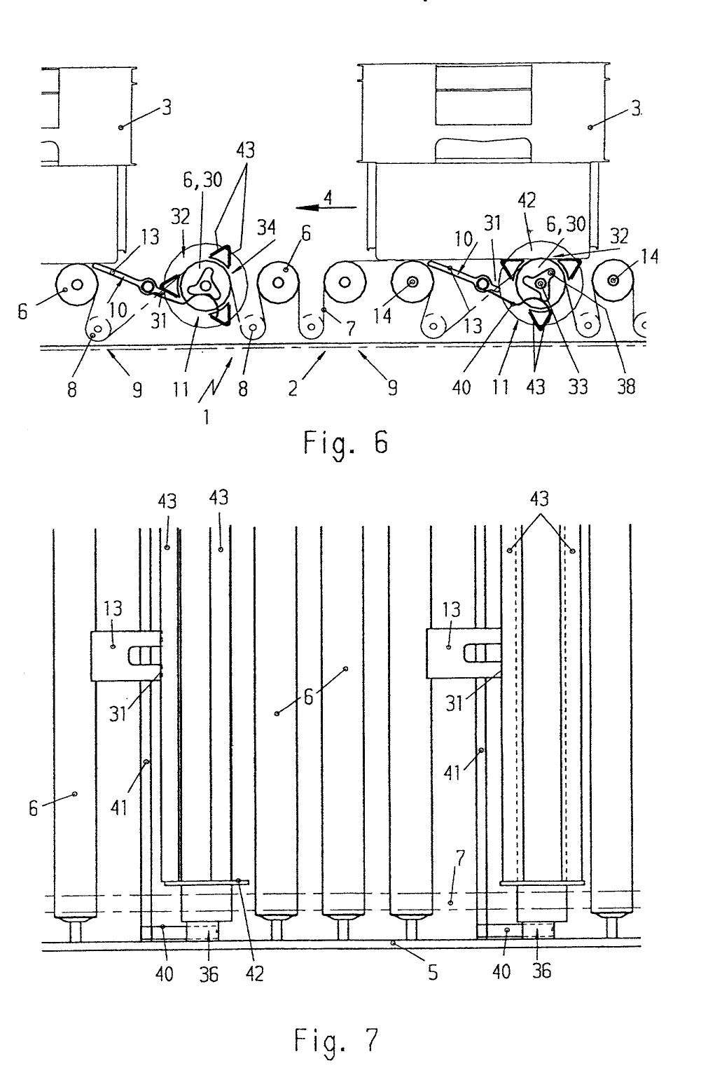

An alternative embodiment of the apparatus 1 is illustrated in FIGS. 6-10. The apparatus 1 of FIGS. 6-10 again is composed of a pick-up section 2 composed of a plurality of drivable rollers 6 which are arranged transversely of the conveying direction 4 of the containers 3 and form a conveying plane. The apparatus 1 of FIGS. 6-10 includes an actuating lever 13 constructed as the switching device 10 which is pivotable about an axis arranged transversely of the conveying direction 4 of the container 3, wherein the actuating lever 13 is configured to be pivotable by a container 3 moved downstream into a position which releasably locks the switching device 10 and locking device 11. For this purpose, a bolt 31 is mounted on the swivel axis opposite the actuating lever 13, wherein the bolt 31 holds in a locking position or locks a stopping member 32 of the locking device 11 which is rotatably mounted about a parallel axis 33, so that mutual locking is produced.

As shown in FIG. 7, the actuating lever 13 is arranged approximately in the middle of the longitudinal axis of the pick-up section; the lever 13 may also have a greater width than illustrated in the drawing.

The locking member 32 includes side surfaces 34 extending parallel to the axis 33 and having an equilateral triangular cross-section uniformly distributed around the axis 33. As illustrated in FIG. 6, even though the actuating lever is in the same position, the locking members 32 are in a different position of operation or in a locking or passing position, wherein the downstream adjacent conveying section 9 is occupied by a container 3, while a container 3 is just being supplied to the upstream conveying section 9.

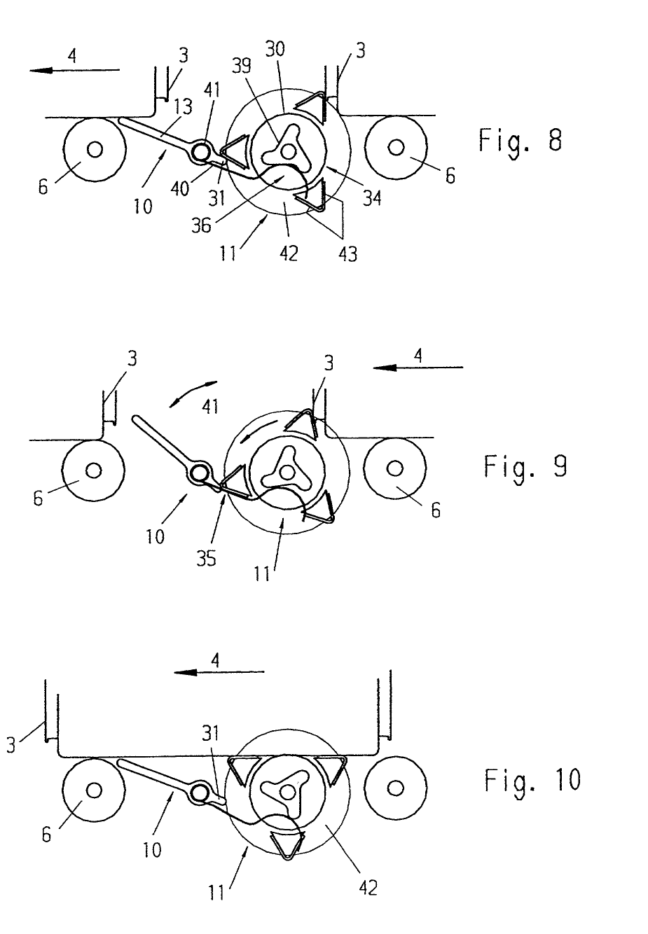

The operation will be discussed in more detail in connection with FIGS. 8-10.

In the locking position, the locking member 32 forms a vertical side surface 34 facing the supplied or arrived container 3 and the locking action is reinforced at the oppositely located triangle edge 35 by the bolt 31 of the actuating lever 13 which is under load of a container 3.

This situation is illustrated in FIG. 8 in which a container 3 located on a conveying section 9 holds the actuating lever 13 under the conveying plane in order to simultaneously with the bolt 31 support the locking member 32 which exerts a pressure by the container 3 which has contacted the locking member 32 on the upstream conveying section 9 as long as the rollers 6 are being rotated.

Incidentally, it has been found that a roller 6 coated with a friction lining does hot have a favorable effect on the conveyance of the containers 3 in all respects because, for example, a slip effect of the rollers 6 at the containers 3 which are being stopped may also lead to wear damage.

FIG. 9 shows a situation in which the upstream container 3 has left the position shown in FIG. 8, so that the pressure developed by the subsequent container 3 on the locking member 32 causes the actuating lever 13 to be lifted upwardly and to cancel the locking action of the locking member 32. As the container 3 moves further, the locking member 32 is rotated further until it assumes the position of FIG. 10 approximately coplanar with the conveying plane.

The container 3 travels further and makes contact with the actuating lever 13 which in the pressed-down position is ready to lock the locking member 32.

As soon as the container 3 has traveled over the locking member 32, the locking member 32 is rotated by an adjusting device 36 into a position in which it forms by a side surface 34 a vertical wall directed upstream and in which it is held in the locked position by the bolt 31. For this purpose, the locking member 32 has at the end face thereof and concentrically to the axis of rotation 33 thereof a locking wheel 38 which has indentations 39 arranged at the circumference thereof and assigned to each side surface 34 of the locking member 32, wherein an appropriately curved plate spring 40 acts on the indentation 39 so as to place the locking wheel 38 or the locking member 32 into the locking position, as shown in FIG. 8.

The frictional force produced by the force of the plate spring 40 overcomes the driving force of the rollers 6 acting on the containers 3, so that the plate spring 40 is lifted along the indentation 39 out of the locking wheel 38, as illustrated in FIGS. 8-10.

It should further be mentioned that the centroidal line formed by the equilateral triangular shape of the locking member 32 and extending transversely of the conveying direction 4 is located in the axis of rotation 33 of the locking member 32.

It has been found that closed side surfaces 34 of the locking member 32 form, because of the required width, an area of the pick-up section 2 which does not cause conveyance. For this reason, it is advantageous if the axis of rotation 33 of the locking member 32 has a roller 30 of the pick-up section 2 which is freely rotatable or is drivably connected to the remaining rollers 6, wherein the diameter of the roller 30 or the circumference of the side surfaces 34, which are interrupted along the axis of rotation 33, protrude so as to cause conveyance.

In this embodiment of the locking member 32, the side surface parts 43 of the side surfaces 34 are attached on freely rotatably mounted flanges 42 arranged laterally of the roller 6, 30.

In order to improve the conveying action of this roller 6 or 30, this roller has a greater diameter than the remaining rollers 6 of the pick-up section 2.

The pick-up section 2 may be divided into groups of several conveying elements 9, wherein the rollers 6, 30 belonging to a group are commonly driven, and the groups, in turn, are controlled so as to be switched on and off. In other words, when there are no gaps between the containers 3 of a group of conveying sections 9, a control switches off the driven rollers 6, 30 of this group.

The invention is not limited by the embodiments described above which are presented as examples only but can be modified in various ways within the scope of protection defined by the appended patent claims.

We claim:

1. A method for effecting a gap-free line-up of containers successively supplied from a pick-up section, wherein the containers are selectively removed from the pick-up section so as to produce a gap, the method comprising filling the gap left by a removed container by triggering an automatic conveyance of a subsequent container by the container removed from the pick-up section and by containers following the removed container on subsequent pick-up sections as seen in a conveying direction of the containers.

2. The method according to claim 1, wherein the containers following in the conveying direction the container removed from the pick-up section transversely of the conveying direction, are caused to be conveyed by a container placed upstream of the containers.

3. The method according to claim 1, wherein the pick-up section includes a plurality of drivable rollers which are arranged transversely of the conveying direction and form a conveying plane, and wherein the pick-up section is formed by a plurality of conveying sections acting as placement locations for the containers, further comprising, when a placement location is occupied by a container, holding up a container placed on an adjacent upstream conveying section on the placement location thereof.

4. The method according to claim 3, wherein a container leaving the placement location thereof downstream releases the container held up on its placement location upstream.

5. The method according to claim 1, comprising supplying the containers one of one behind the other in an arrangement direction thereof on the pick-up section and transversely next to each other to the pick-up section.

6. An apparatus for effecting a gap-free line-up of containers, the apparatus comprising a pick-up section for successively supplied containers, the pick-up section comprising drivable rollers arranged transversely of a conveying direction of the containers and forming a conveying plane, wherein the pick-up section comprises a plurality of conveying sections arranged in a row in the conveying direction of the containers, wherein the conveying sections are configured as placement locations for the containers, further comprising means for switching on and off the placement locations by the containers or by a removal of a container transversely of the conveying direction.

7. The apparatus to claim 6, wherein the conveying sections of the pick-up section are arranged one of one behind the other and next to one another.

8. The apparatus according to claim 6, further comprising a switching device assigned between two successive conveying sections to the placement location of the adjacent downstream conveying section, wherein the switching device is configured to be actuated by a container, and wherein the switching device is connected to a stopping element of a locking device for the placement location of the adjacent upstream conveying section, wherein the stopping element is configured to be switched on and off.

9. The apparatus according to claim 8, wherein the switching device connected to the locking device is configured to be movable by a container placed on the placement location of a conveying section into a locking position which stops the conveyance of the containers at the adjacent upstream conveying section.

10. The apparatus according to claim 9, wherein the switching device comprises an actuating lever mounted so as to be pivotable about an axis arranged transversely of the conveying direction of the containers and so as to be pivotable into the conveying plane by a container moved on a conveying section for releasably locking the switching device and the locking device, and wherein the switching device comprises a pawl for engagement in the actuating lever, wherein the pawl is hinged to the stopping element of the locking device constructed so as to be pivotable as a lever about a parallel axis.

11. The apparatus according to claim 10, wherein the pawl has an expanded recess for limiting a pivoting movement of the pawl, wherein the recess surrounds a shaft arranged in the axis of the actuating lever.

12. The apparatus according to claim 11, wherein the pawl has a guide stop for limiting the pivoting movement of the actuating lever out of the conveying plane.

13. The apparatus according to claim 12, wherein the actuating lever has on an oppositely located side of the axis a cam for engagement of the pawl.

14. The apparatus according to claim 10, comprising a pretensioned spring connecting the actuating lever for lifting the actuating lever out of the conveying plane and the stopping element of the locking device constructed as a lever.

15. The apparatus according to claim 14, wherein a pulling force required of the spring for raising the actuating lever and the stopping element is smaller than a force produced by a container making contact with the stopping element constructed as a lever.

16. The apparatus according to claim 6, wherein axes of the actuating lever and the stopping element are distributed concentrically on axes of two adjacent rollers.

17. The apparatus according to claim 16, comprising a switching device and locking device each on both sides of the pick-up section for two adjacent conveyor sections.

18. The apparatus according to claim 17, wherein the stopping element of the locking device is comprised of at least one rod extending transversely of the conveying direction of the containers.

19. The apparatus according to claim 6, comprising an endless traction means connecting the rollers for driving the rollers.

20. The apparatus according to claim 16, wherein the switching device and the locking device are arranged approximately in a longitudinal middle of the pick-up section.

21. The apparatus according to claim 20, wherein rollers having common axes with the switching device and the locking device have a center cutout portion.

22. The apparatus according to claim 6, wherein the switching device comprises an actuating lever mounted so as to be pivotable about an axis arranged transversely of the conveying direction of the containers and configured to be actuated by a conveyor being moved downstream for releasably locking the switching device and the locking device, wherein the actuating lever comprises a bolt mounted oppositely on the pivot axis for holding in a locked position a locking member of the locking device arranged so as to be rotatable about a parallel axis.

23. The apparatus according to claim 22, wherein the locking member comprises side surfaces extending parallel to the axis and having an equilateral triangular shape distributed uniformly about the axis.

24. The apparatus according to claim 23, wherein the locking member forms in a locking position thereof a vertical side surface facing the supplied container, wherein an oppositely located edge of the triangle is supported by the bolt of the actuating lever when under load by a container.

25. The apparatus according to claim 24, wherein after locking has been cancelled by a rotary movement caused by the travelling container, the vertical side surface of the locking member forms a coplanar plane with the conveying plane of the pick-up section.

26. The apparatus according to claim 22, comprising an adjusting device for moving the locking member in a free-standing position into the locking position.

27. The apparatus according to claim 23, wherein a centroidal line of the locking member having an equilateral triangular cross-section forms the axis of rotation thereof.

28. The apparatus according to claim 22, wherein the axis of rotation of the locking member comprises an additional roller connected so as to be driven with the remaining rollers of the pick-up section, wherein the additional roller protrudes beyond the circumference of interrupted side surfaces of the locking member for effecting conveyance.

29. The apparatus according to claim 28, wherein the additional roller of the locking member has a greater diameter than the remaining rollers of the pick-up section.

30. The apparatus according to claim 28, wherein the interrupted side surfaces of the locking member are fastened to flanges mounted so as to be freely rotatable laterally of the additional roller.

31. The apparatus according to claim 22, wherein the locking member has a length which corresponds at least approximately to a length of a supporting roller of the pick-up section.

32. The apparatus according to claim 22, wherein the actuating lever is attached to a shaft extending parallel to the axis of rotation of the locking member.

33. The apparatus according to claim 26, wherein at least an end face of the locking member comprises a locking wheel for engagement of a plate spring attached to the frame.

34. The apparatus according to claim 33, wherein the plate spring is mounted so that a force thereof acts on the side surfaces of the locking member.

35. The apparatus according to claim 6, wherein the pick-up section comprises groups of several conveying elements.

36. The apparatus according to claim 35, wherein the groups have commonly driven rollers, further comprising means for controlling the groups so as to switch on and off the rollers.
